(19) United States
(12) Patent Application Publication
(10) Pub. No.: US 2019/0392382 A1
(43) Pub. Date: Dec. 26, 2019

(54) REFRIGERATOR FOR MANAGING ITEM USING ARTIFICIAL INTELLIGENCE AND OPERATING METHOD THEREOF

(71) Applicant: LG ELECTRONICS INC., Seoul (KR)

(72) Inventor: Jongwoo HAN, Seoul (KR)

(73) Assignee: LG ELECTRONICS INC., Seoul (KR)

(21) Appl. No.: 16/561,740

(22) Filed: Sep. 5, 2019

(30) Foreign Application Priority Data
Aug. 9, 2019 (KR) 10-2019-0097388

(51) Int. Cl. G06Q 10/08; G06N 3/00; F25D 29/00; G06K 9/62

(52) U.S. Cl. CPC G06Q 10/087; G06N 3/004; F25D 2500/06; G06K 9/6201; F25D 2700/06; F25D 29/005

(57) ABSTRACT

A refrigerator which manages an item using artificial intelligence according to an embodiment of the present invention includes a communication unit configured to communicate with another refrigerator; a camera configured to image an inner portion of the refrigerator; and a processor configured to acquire a stock state information of the item from another refrigerator through the communication unit, in a case where the processor detects that the item is taken in or taken out from the refrigerator based on an image photographed by the camera, and to output management guide of the item, based on the acquired stock state information of the item.

### BACKGROUND

The present invention relates to a refrigerator for managing an item using artificial intelligence.

In general, the refrigerator refers to a storeroom which can store and preserve food and item at low temperatures for a long time by a refrigeration cycle which circulates refrigerant to exchange heat in a storage space for storing food and an item.

Recently, refrigerators have various additional functions, namely, input functions, display functions, Internet functions, and the like, unlike the one which is performed only a limited function of storing and preserving food and an item.

In particular, the refrigerator is linked to IoT service, the ability to determine the stock state of an item, and to recommend the purchase of an item has also appeared. In addition, at least two refrigerators, such as a main refrigerator, a kimchi refrigerator, a small refrigerator, and the like are often provided in a house.

However, conventionally, each refrigerator only manages own stock an item therein but has not grasped the stock state of the stock an item of other refrigerators.

As a result, there is a problem in that item management is not performed efficiently.

### SUMMARY

An object of the present invention is to manage an item by the plurality of refrigerators sharing a stock state of an item therein, in a case where a plurality of refrigerators are provided in a house.

An object of the present invention is to provide a refrigerator which efficiently manages an item in consideration of a stock state of the item with another refrigerator when detecting that an item is taken in or take out of the refrigerator.

A refrigerator which manages an item using artificial intelligence according to an embodiment of the present invention includes a communication unit configured to communicate with another refrigerator; a camera configured to image an inner portion of the refrigerator; and a processor configured to acquire a stock state information of the item from another refrigerator through the communication unit, in a case where the processor detects that the item is taken in or taken out from the refrigerator based on an image photographed by the camera, and to output management guide of the item, based on the acquired stock state information of the item.

A method for managing an item of a refrigerator which manages an item, using artificial intelligence according to an embodiment of the present invention, the method includes imaging an inner portion of the refrigerator; acquiring stock state information of the item from another refrigerator, in a case where it is detected that the item is taken in or taken out from the refrigerator, based on an image photographed by a camera; and outputting management guide of the item, based on the acquired stock state information of the item.

According to an embodiment of the present invention, the user may be provided with item management guide which automatically reflects the stock state of each refrigerator without any intervention.

Accordingly, the user can easily perform the item management of the refrigerator.

### BRIEF DESCRIPTION OF THE DRAWING

FIG. 1 illustrates an AI device according to an embodiment of the present invention.

FIG. 2 illustrates an AI server according to an embodiment of the present invention.

FIG. 3 illustrates an AI system according to an embodiment of the present invention.

FIG. 4 illustrates an AI device according to another embodiment of the present invention.

FIG. 5 is a flowchart illustrating an item management method of a refrigerator in accordance with one embodiment of the present invention.

FIG. 6 is a ladder diagram illustrating an item management method of a refrigeration system according to an embodiment of the present invention.

FIGS. 7 and 8 are diagrams illustrating a specific scenario with respect to an item management method of a refrigeration system in a case where an item is taken out from the refrigerator according to an embodiment of the present invention.

FIG. 9 is a ladder diagram illustrating an item management method of a refrigeration system according to another embodiment of the present invention.

FIG. 10 is a view for explaining a specific scenario with respect to the item management method of the refrigeration system, in a case where the item is taken in the refrigerator according to an embodiment of the present invention.

FIG. 11 is a view for explaining an example in which the first refrigerator and the second refrigerator automatically perform item management without user intervention, according to an embodiment of the present invention.

### DETAILED DESCRIPTION OF THE EMBODIMENTS

### Artificial Intelligence (AI)

Artificial intelligence means a field of researching man-made intelligence or the methodology which can produce the man-made intelligence, and machine learning means a field of researching methodologies which define and solve various problems in the field of artificial intelligence. Machine learning is defined as an algorithm that improves the performance of a task through a consistent experience with respect to a task.

Artificial Neural Network (ANN) is a model used in machine learning and may mean a whole model having problem-solving ability composed of artificial neurons (nodes) formed by a combination of synapses. The artificial neural network may be defined by a connection pattern between neurons of different layers, a learning process of updating model parameters, and an activation function generating an output value.

The artificial neural network may include an input layer, an output layer, and optionally one or more hidden layers. Each layer includes one or more neurons, and the artificial neural network may include synapses which connect neurons to neurons. In an artificial neural network, each neuron may output a function value of an active function for input signals, weights, and deflections input through a synapse.

The model parameter means a parameter determined through learning and includes weights of synaptic connections and deflection of neurons. In addition, the hyper-parameter means a parameter to be set before learning in the machine learning algorithm and includes a learning rate, the number of iterations, a mini-batch size, and an initialization function.

The purpose of learning artificial neural networks can be seen as determining model parameters which minimize the loss function. The loss function can be used as an index for determining optimal model parameters in the learning process of artificial neural networks.

Machine learning can be categorized into supervised learning, unsupervised learning, and reinforcement learning.

Supervised learning means a method of learning artificial neural networks in a state where a label for learning data is given, and a label can mean a correct answer (or result value) that the artificial neural network must infer in a case where the learning data is input to the artificial neural network. Unsupervised learning may mean a method of learning artificial neural networks in a state where a label for learning data is not given. Reinforcement learning can mean a learning method which allows an agent defined in an environment to learn to choose actions which maximize cumulative reward in each state or sequence of the actions.

Machine learning, which is implemented as a deep neural network (DNN) which includes a plurality of hidden layers among artificial neural networks, is called deep learning, which is a portion of machine learning. In the following, machine learning is used to mean deep learning.

### Robot

A robot can mean a machine which automatically handles or operates a given task by own ability thereof. In particular, a robot having functions of recognizing the environment, determining itself, performing the operation may be referred to as an intelligent robot.

Robots can be classified into industrial, medical, household, military, or the like according to the purpose or field of use.

The robot may include a driving unit including an actuator or a motor to perform various physical operations such as moving a robot joint. In addition, the movable robot includes a wheel, a brake, a propeller, and the like in the driving unit, and can drive on the ground or fly in the air through the driving unit.

### Self-Driving

Self-driving means a technology which drives by itself, and autonomous vehicle means a vehicle which drives without a user's manipulation or with minimal manipulation of a user.

For example, autonomous driving may include the technology of maintaining a driving lane, the technology of automatically adjusting speed such as adaptive cruise control, the technology of automatically driving along a predetermined path, the technology of automatically setting a path when a destination is set, or the like.

The vehicle may include all a vehicle having only an internal combustion engine, a hybrid vehicle having an internal combustion engine and an electric motor together, and an electric vehicle having only an electric motor and may include not only automobiles but also trains, motorcycles, or the like.

At this time, the autonomous vehicle may be viewed as a robot having an autonomous driving function.

### Extended Reality (XR)

Extended reality collectively refers to Virtual Reality (VR), Augmented Reality (AR), and Mixed Reality (MR). VR technology provides real-world objects, backgrounds, or the like only in CG images, AR technology provides virtual CG images on real objects images, and MR technology is computer graphic technology which mixes and combines virtual objects in the real world.

MR technology is similar to AR technology in that the MR technology illustrates both real and virtual objects. However, in AR technology, the virtual object is used as a complementary form to the real object, whereas in the MR technology, the virtual object and the real object are used in the same nature.

XR technology can be applied to Head-Mount Display (HMD), Head-Up Display(HUD), mobile phone, tablet PC, laptop, desktop, TV, digital signage, or the like and a device to which XR technology is applied may be referred to as an XR device.

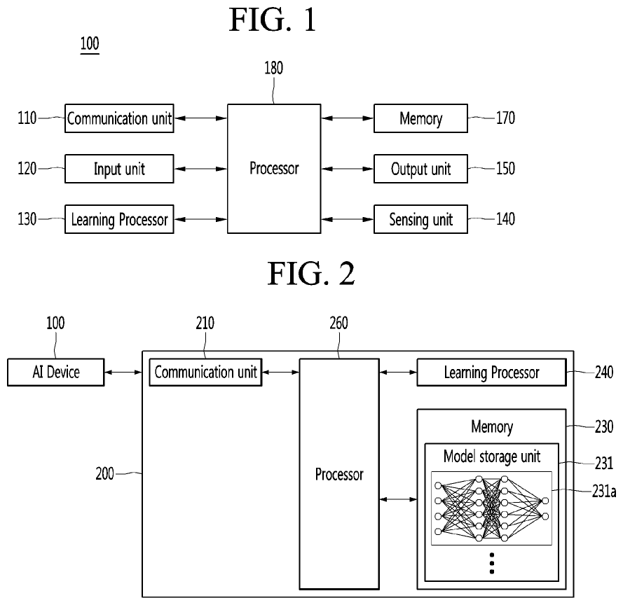

FIG. 1 illustrates an AI device 100 according to an embodiment of the present invention.

The AI device 100 may be implemented as a fixed device, a movable device, or the like such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, and a vehicle.

Referring to FIG. 1, the terminal 100 may include a communication unit 110, an input unit 120, a learning processor 130, a sensing unit 140, an output unit 150, a memory 170, a processor 180, and the like.

The communication unit 110 may transmit or receive data to or from external devices such as the other AI devices 100a to 100e or the AI server 200 using wired or wireless communication technology. For example, the communication unit 110 may transmit or receive sensor information, a user input, a learning model, a control signal, and the like with external devices.

In this case, the communication technology used by the communication unit 110 may include Global System for Mobile communication (GSM), Code Division Multi-Access (CDMA), Long Term Evolution (LTE), 5G, Wireless LAN (WLAN), and Wireless-Fidelity (Wi-Fi), Bluetooth™, Radio Frequency Identification (RFID), Infrared Data Association (IrDA), ZigBee, Near Field Communication (NFC), or the like.

The input unit 120 may acquire various types of data.

At this time, the input unit 120 may include a camera for inputting an image signal, a microphone for receiving an audio signal, a user input unit for receiving information from a user, and the like. Here, the signal acquired from the camera or microphone may be referred to as sensing data or sensor information by managing the camera or microphone as a sensor.

The input unit 120 may acquire input data to be used when acquiring an output using learning data and a learning model for model learning. The input unit 120 may acquire raw input data, and in this case, the processor 180 or the learning processor 130 may extract input feature points as preprocessing on the input data.

The learning processor 130 may learn a model composed of artificial neural networks using the learning data. Here, the learned artificial neural network may be referred to as a learning model. The learning model may be used to infer result values for new input data other than the learning data, and the inferred values may be used as a basis for the determination to perform an operation.

At this time, the learning processor 130 may perform AI processing together with the learning processor 240 of the AI server 200.

In this case, the learning processor 130 may include a memory integrated with or implemented in the AI device 100. Alternatively, the learning processor 130 may be implemented using a memory 170, an external memory directly coupled to the AI device 100, or a memory held in the external device.

The sensing unit 140 may acquire at least one of internal information of the AI device 100, surrounding environment information of the AI device 100, and user information using various sensors.

In this case, the sensors included in the sensing unit 140 include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, a radar, or the like.

The output unit 150 may generate an output related to sight, hearing, touch, or the like.

At this time, the output unit 150 may include a display unit for outputting visual information, a speaker for outputting auditory information, and a haptic module for outputting tactile information.

The memory 170 may store data supporting various functions of the AI device 100. For example, the memory 170 may store input data, learning data, learning model, learning history, and the like acquired by the input unit 120.

The processor 180 may determine at least one executable operation of the AI device 100 based on the information determined or generated using the data analysis algorithm or the machine learning algorithm. In addition, the processor 180 may control the components of the AI device 100 to perform the determined operation.

To this end, the processor 180 may request, search, receive, or utilize data of the learning processor 130 or the memory 170, and may control the components of the AI device 100 so as to execute an operation predicted or an operation determined to be preferable among the at least one executable operation.

At this time, in a case where the external device needs to be linked to perform the determined operation, the processor 180 may generate a control signal for controlling the corresponding external device and transmit the generated control signal to the corresponding external device.

The processor 180 may acquire intention information about the user input, and determine the user's requirements based on the acquired intention information.

At this time, the processor 180 uses at least one of a speech to text (STT) engine for converting voice input into a string or a natural language processing (NLP) engine for acquiring intent information of a natural language and thus intent information corresponding to the user's input can be acquired.

At this time, at least one of the STT engine or the NLP engine may be configured as an artificial neural network, at least partly learned according to a machine learning algorithm. At least one of the STT engine or the NLP engine may be learned by the learning processor 130, may be learned by the learning processor 240 of the AI server 200, or may be learned by distributed processing thereof.

The processor 180 can collect history information including operation contents of the AI device 100, feedback of a user about the operation, or the like, and thus store the collected history information in the memory 170 or the learning processor 130, or transmit to an external device such as the AI server 200. The collected historical information can be used to update the learning model.

The processor 180 may control at least some of the components of the AI device 100 to drive an application program stored in the memory 170. In addition, the processor 180 may operate two or more of the components included in the AI device 100 in combination with each other to drive the application program.

FIG. 2 illustrates an AI server 200 according to an embodiment of the present invention.

Referring to FIG. 2, the AI server 200 may mean a device for learning artificial neural network using a machine learning algorithm or using a learned artificial neural network. Here, the AI server 200 may be composed of a plurality of servers to perform distributed processing or may be defined as a 5G network. At this time, the AI server 200 may be included as a configuration of a portion of the AI device 100 to perform at least some of the AI processing together.

The AI server 200 may include a communication unit 210, a memory 230, a learning processor 240, a processor 260, and the like.

The communication unit 210 may transmit and receive data with an external device such as the AI device 100.

The memory 230 may include a model storage unit 231. The model storage unit 231 may store a model being learned or learned (or an artificial neural network 231a) through the learning processor 240.

The learning processor 240 may train the artificial neural network 231a using the learning data. The learning model may be used while mounted in the AI server 200 of the artificial neural network or may be mounted and used in an external device such as the AI device 100.

The learning model can be implemented in hardware, software or a combination of hardware and software. In a case where some or all the learning model is implemented in software, one or more instructions constituting the learning model may be stored in the memory 230.

The processor 260 may infer a result value with respect to the new input data using the learning model, and generate a response or control command based on the inferred result value.

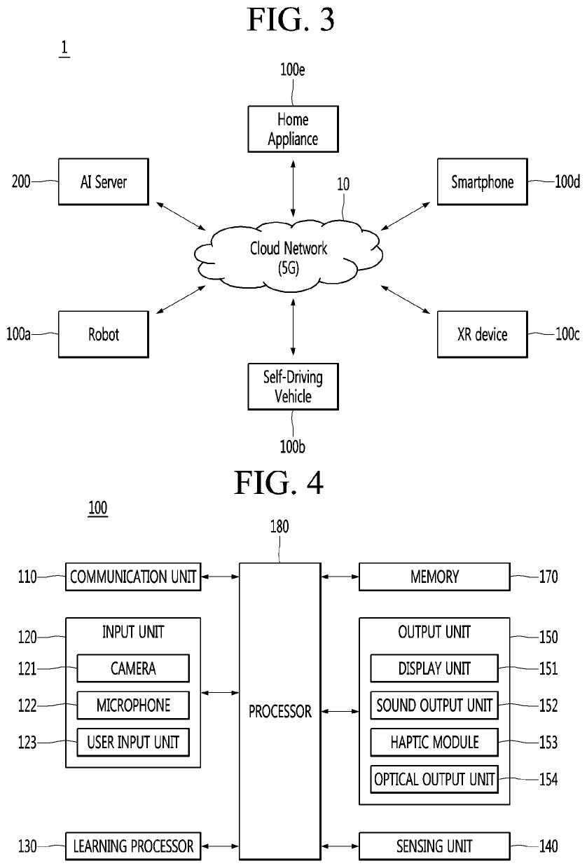

FIG. 3 illustrates an AI system 1 according to an embodiment of the present invention.

Referring to FIG. 3, in the AI system 1, at least one of an AI server 200, a robot 100a, an autonomous vehicle 100b, an XR device 100c, a smartphone 100d, or a home appliance 100e is connected to a cloud network 10. Here, the robot 100a to which the AI technology is applied, the autonomous vehicle 100b, the XR device 100c, the smartphone 100d or the home appliance 100e may be referred to as the AI devices 100a to 100e.

The cloud network 10 may mean a network which forms a portion of a cloud computing infrastructure or exists within the cloud computing infrastructure. Here, the cloud network 10 may be configured using a 3G network, 4G or Long Term Evolution (LTE) network or a 5G network.

In other words, the devices 100a to 100e and 200 constituting the AI system 1 may be connected to each other through the cloud network 10, respectively. In particular, although the devices 100a to 100e and 200 may communicate with each other through the base station, respectively, the devices 100a to 100e and 200 may also communicate with each other directly without passing through the base station.

The AI server 200 may include a server which performs AI processing and a server which performs operations on big data.

The AI server 200 may be connected to at least one of a robot 100a, an autonomous vehicle 100b, an XR device 100c, a smartphone 100d, and a home appliance 100e, which are AI devices constituting the AI system 1 through the cloud network 10 and may help at least a portion of the AI processing of the connected AI devices 100a to 100e.

At this time, the AI server 200 may learn artificial neural network according to the machine learning algorithm on behalf of the AI devices 100a to 100e and directly store the learning model or transmit the learning model to the AI devices 100a to 100e.

At this time, the AI server 200 can receive input data from the AI devices 100a to 100e, infer a result value with respect to the received input data using a learning model, and generate a response or control command based on the inferred result value and thus transmit the response or control command to the AI device 100a to 100e.

Alternatively, the AI devices 100a to 100e may infer a result value from input data using a direct learning model and generate a response or control command based on the inferred result value.

Hereinafter, various embodiments of the AI devices 100a to 100e to which the above-described technology is applied will be described. Here, the AI devices 100a to 100e illustrated in FIG. 3 may be viewed as specific embodiments of the AI device 100 illustrated in FIG. 1.

### AI+Robot

The robot 100a may be applied to an AI technology and may be implemented as a guide robot, a transport robot, a cleaning robot, a wearable robot, an entertainment robot, a pet robot, an unmanned flying robot, or the like.

The robot 100a may include a robot control module for controlling operation, and the robot control module may mean a software module or a chip that implements the software module in hardware.

The robot 100a can acquire state information of the robot 100a by using sensor information acquired from various types of sensors, detect (recognizes) the surrounding environment and an object, generate map data, determine moving paths and driving plans, determine responses to user interactions, or determine operations.

Here, the robot 100a may use sensor information acquired from at least one sensor among a lidar, a radar, and a camera to determine moving paths and driving plan.

The robot 100a may perform the above-described operations by using a learning model composed of at least one artificial neural network. For example, the robot 100a may recognize a surrounding environment and an object using a learning model, and determine an operation using the recognized surrounding environment information or object information. Here, the learning model may be directly learned by the robot 100a or may be learned by an external device such as the AI server 200.

At this time, the robot 100a may perform an operation by generating a result using a direct learning model, but transmit sensor information to an external device such as the AI server 200 and receive the result generated accordingly to perform an operation.

The robot 100a can determine moving paths and driving plans by using at least one of map data, object information detected from sensor information, or object information acquired from an external device, and control the driving unit and thus derive the robot 100a according to the determined moving paths and driving plans.

The map data may include object identification information on various objects disposed in space in which the robot 100a moves. For example, the map data may include object identification information on fixed objects such as walls and doors and movable objects such as flower pots and desks. The object identification information may include a name, type, distance, location, and the like.

In addition, the robot 100a may control the driving unit based on the control/interaction of the user, thereby performing an operation or driving. In this case, the robot 100a may acquire the intention information of the interaction according to the user's motion or voice utterance, and determine a response based on the acquired intention information to perform the operation.

### AI+Autonomous Driving

An AI technology is applied to the autonomous vehicle 100b, and the autonomous vehicle 100b can be implemented as a mobile robot, a vehicle, an unmanned aerial vehicle, or the like.

The autonomous vehicle 100b may include an autonomous driving control module for controlling the autonomous driving function, and the autonomous driving control module may mean a software module or a chip that implements the software module in hardware. The autonomous driving control module may be included inside as a configuration of the autonomous driving vehicle 100b but may be connected to the outside of the autonomous driving vehicle 100b as separate hardware.

The autonomous vehicle 100b can acquire state information of the autonomous vehicle 100b by using sensor information acquired from various types of sensors, detect (recognize) the surrounding environment and an object, generates map data, determine moving paths and driving plans, or determine operations.

Here, the autonomous vehicle 100b may use sensor information acquired from at least one sensor among a lidar, a radar, and a camera, similar to the robot 100a, to determine moving paths and driving plans.

In particular, the autonomous vehicle 100b may receive and recognize sensor information from external devices or receive information directly recognized from the external devices with respect to the environment or object for the area which is hidden from view or for an area over a certain distance.

The autonomous vehicle 100b may perform the above operations by using a learning model composed of at least one artificial neural network. For example, the autonomous vehicle 100b may recognize a surrounding environment and an object using a learning model, and determine a driving line using the recognized surrounding environment information or object information. Here, the learning model may be learned directly from the autonomous vehicle 100b or may be learned from an external device such as the AI server 200.

At this time, the autonomous vehicle 100b can perform an operation by generating a result using a direct learning model, but transmit sensor information to an external device such as the AI server 200, receive the result generated according to this and perform the operation.

The autonomous vehicle 100b can determine moving paths and driving plans by using at least one of map data, object information detected from sensor information, or object information acquired from an external device, and control the driving unit and thus the autonomous vehicle 100b can be driven according to determined the moving paths and the driving plans.

The map data may include object identification information for various objects disposed in space (for example, a road) on which the autonomous vehicle 100b drives. For example, the map data may include object identification information on fixed objects such as street lights, rocks, buildings, and movable objects such as vehicles and pedestrians. The object identification information may include a name, type, distance, location, and the like.

In addition, the autonomous vehicle 100b may perform an operation or drive by controlling the driving unit based on the user's control/interaction. At this time, the autonomous vehicle 100b may acquire the intention information of the interaction according to the user's motion or voice utterance and determine the response based on the acquired intention information to perform the operation.

### AI+XR

The XR device 100c is applied with AI technology, and can be implemented by a head-mount display (HMD), a head-up display (HUD) installed in a vehicle, a television, a mobile phone, a smartphone, a computer, a wearable device, a home appliance, a digital signage, a vehicle, a fixed robot, a mobile robot, or the like.

The XR device 100c analyzes three-dimensional point cloud data or image data acquired through various sensors or from an external device to generate location data and attribute data for three-dimensional points, thereby acquiring information on the surrounding space or reality object and rendering XR object to output the XR object. For example, the XR device 100c may output an XR object including additional information on the recognized object in correspondence with the recognized object.

The XR device 100c may perform the above-described operations using a learning model composed of at least one artificial neural network. For example, the XR device 100c may recognize a real object in 3D point cloud data or image data using a learning model and may provide information corresponding to the recognized reality object. Here, the learning model may be a model which is learned directly from the XR device 100c or learned from an external device such as the AI server 200.

At this time, the XR device 100c can perform an operation by generating a result using a direct learning model, but transmit sensor information to an external device such as the AI server 200 and receive the result generated accordingly to perform the operation.

### AI+Robot+Autonomous Driving

The robot 100a may be applied with an AI technology and an autonomous driving technology, and may be implemented as a guide robot, a transport robot, a cleaning robot, a wearable robot, an entertainment robot, a pet robot, an unmanned flying robot, or the like.

The robot 100a to which the AI technology and the autonomous driving technology are applied may mean a robot itself having an autonomous driving function or a robot 100a interacting with the autonomous vehicle 100b.

The robot 100a having an autonomous driving function may collectively mean devices which move according to a given moving line by itself or move by determining a moving line by itself even without the user's control.

The robot 100a and the autonomous vehicle 100b having the autonomous driving function may use a common sensing method to determine one or more of moving paths or driving plans. For example, the robot 100a and the autonomous vehicle 100b having the autonomous driving function may determine one or more of the moving paths or the driving plans by using information sensed through the lidar, the radar, and the camera.

The robot 100a, which interacts with the autonomous vehicle 100b, is present separately from the autonomous vehicle 100b and can perform operations which are linked to the autonomous driving function inside the autonomous vehicle 100b or linked to the user boarding to the autonomous vehicle 100b.

At this time, the robot 100a interacting with the autonomous vehicle 100b acquires sensor information on behalf of the autonomous vehicle 100b and provides the sensor information to the autonomous vehicle 100b or acquires the sensor information, generates surrounding environment information or object information and provides the surrounding environment information or the object information to the autonomous vehicle 100b, and thus can control or assist the autonomous driving function of the autonomous vehicle 100b.

Alternatively, the robot 100a interacting with the autonomous vehicle 100b may monitor a user in the autonomous vehicle 100b or control a function of the autonomous vehicle 100b through interaction with the user. For example, in a case where it is determined that the driver is in a drowsy state by the robot 100a, the robot 100a may activate the autonomous driving function of the autonomous vehicle 100b or assist control of the driving unit of the autonomous vehicle 100b. Here, the function of the autonomous vehicle 100b controlled by the robot 100a may include not only an autonomous driving function but also a function provided by a navigation system or an audio system provided inside the autonomous vehicle 100b.

Alternatively, the robot 100a interacting with the autonomous vehicle 100b may provide information or assist a function to the autonomous vehicle 100b outside the autonomous vehicle 100b. For example, the robot 100a may provide traffic information including signal information and the like to the autonomous vehicle 100b like a smart traffic light, interact with the autonomous vehicle 100b like an automatic electric charger of an electric vehicle and thus may also automatically connect an electric charger to a charging port.

### AI+Robot+XR

The robot 100a may be applied with an AI technology and an XR technology, and may be implemented as a guide robot, a transport robot, a cleaning robot, a wearable robot, an entertainment robot, a pet robot, an unmanned flying robot, a drone, or the like.

The robot 100a to which the XR technology is applied may mean a robot which is the object of control/interaction in the XR image. In this case, the robot 100a may be distinguished from the XR device 100c and interlocked with each other.

When the robot 100a which is the object of control/interaction in the XR image acquires sensor information from sensors including a camera, the robot 100a or the XR device 100c generates an XR image based on the sensor information and the XR device 100c may output the generated XR image. The robot 100a may operate based on a control signal input through the XR device 100c or user interaction.

For example, the user may check an XR image corresponding to the viewpoint of the robot 100a which is remotely interlocked through an external device such as the XR device 100c, adjust the autonomous driving path of the robot 100a through interaction. control the movement or driving, or check the information of the surrounding objects.

### AI+Autonomous Driving+XR

The autonomous vehicle 100b may be applied with an AI technology and an XR technology, and be implemented as a mobile robot, a vehicle, an unmanned aerial vehicle, and the like.

The autonomous vehicle 100b to which the XR technology is applied may mean an autonomous vehicle provided with means for providing an XR image, an autonomous vehicle which is the object of control/interaction in the XR image, or the like. In particular, the autonomous vehicle 100b, which is the object of control/interaction in the XR image, may be distinguished from the XR device 100c and be interlocked with each other.

The autonomous vehicle 100b having means for providing an XR image may acquire sensor information from sensors including a camera and output an XR image generated based on the acquired sensor information. For example, the autonomous vehicle 100b may provide an XR object corresponding to a real object or an object on the screen by providing a HUD to output an XR image.

In this case, in a case where the XR object is output to the HUD, at least a portion of the XR object may be output to overlap the actual object to which the occupant's eyes are directed. On the other hand, in a case where the XR object is output on the display provided inside the autonomous vehicle 100b, at least a portion of the XR object may be output to overlap the object in the screen. For example, the autonomous vehicle 100b may output XR objects corresponding to objects such as a road, another vehicle, a traffic light, a traffic sign, a motorcycle, a pedestrian, a building, and the like.

When the autonomous vehicle 100b which is the object of control/interaction in the XR image acquires sensor information from sensors including a camera, the autonomous vehicle 100b or the XR device 100c may generate the XR image based on the sensor information and the XR device 100c may output the generated XR image. In addition, the autonomous vehicle 100b may operate based on a user's interaction or a control signal input through an external device such as the XR device 100c.

FIG. 4 illustrates an AI device 100 according to an embodiment of the present invention.

Description overlapping with FIG. 1 will be omitted.

Referring to FIG. 4, the input unit 120 may include a camera 121 for inputting an image signal, a microphone 122 for receiving an audio signal, a user input unit for receiving information from a user 123.

The voice data or the image data collected by the input unit 120 may be analyzed and processed as a user's control command.

The input unit 120 is for inputting image information (or signal), audio information (or signal), data, or information input from a user and in order to input image information, the AI device 100 may include one or a plurality of cameras 121.

The camera 121 processes image frames such as still images or moving images acquired by the image sensor in the video call mode or the imaging mode. The processed image frame may be displayed on the display unit 151 or stored in the memory 170.

The microphone 122 processes external sound signals into electrical voice data. The processed voice data may be variously used according to a function (or an application program being executed) performed by the AI device 100. Meanwhile, various noise removing algorithms may be applied to the microphone 122 to remove noise generated in the process of receiving an external sound signal.

The user input unit 123 is for receiving information from a user, and when information is input through the user input unit 123, the processor 180 may control an operation of the AI device 100 to correspond to the input information.

The user input unit 123 may include a mechanical input means (or a mechanical key, for example, a button, a dome switch, a jog wheel, a jog switch, or the like, located on the front surface/the rear surface or side surfaces of the terminal 100) and a touch input means. As an example, the touch input means may include a virtual key, a soft key, or a visual key displayed on the touch screen through a software process, or include a touch key disposed in a portion other than the touch screen.

The output unit 150 may include at least one of a display unit 151, a sound output unit 152, a haptic module 153, and an optical output unit 154.

The display unit 151 displays (outputs) information processed by the AI device 100. For example, the display unit 151 may display execution screen information of an application program driven by the AI device 100, or User Interface (UI) or Graphic User Interface (GUI) information according to the execution screen information.

The display unit 151 forms a layer structure with each other or is integrally formed with the touch sensor, thereby implementing a touch screen. The touch screen may function as a user input unit 123 which provides an input interface between the AI device 100 and the user and may provide an output interface between the terminal 100 and the user.

The sound output unit 152 may output audio data received from the communication unit 110 or stored in the memory 170 in a call signal reception, a call mode or a recording mode, a voice recognition mode, a broadcast reception mode, and the like.

The sound output unit 152 may include at least one of a receiver, a speaker, and a buzzer.

The haptic module 153 generates various haptic effects that a user can feel. A representative example of the tactile effect generated by the haptic module 153 may be vibration.

The light output unit 154 outputs a signal for notifying the occurrence of an event by using light of a light source of the AI device 100. Examples of events generated in the AI device 100 may be message reception, call signal reception, missed call, alarm, schedule notification, email reception, information reception through an application, and the like.

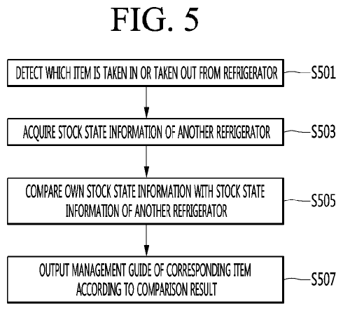

FIG. 5 is a flowchart illustrating a method for manage an item of a refrigerator in accordance with one embodiment of the present invention.

In FIG. 5, the refrigerator described may include all the components of FIG. 4.

The refrigerator may be an example of the excitation device 100e of FIG. 3.

Referring to FIG. 5, the processor 180 of the refrigerator detects that an item is taken in or taken out from the refrigerator (S501).

In an embodiment, the camera 121 may be provided inside the refrigerator. The camera 121 may image the inside of the refrigerator. The processor 180 may detect that an item is taken in or taken out from the refrigerator based on the photographed image.

The processor 180 may detect that a specific item is taken in or taken out from the refrigerator using the image recognition model.

The image recognition model may be a model for identifying an item included in an image by using image data.

The image recognition model may be an artificial neural network based model learned by a deep learning algorithm or a machine learning algorithm. The image recognition model may be learned through supervised learning.

The learning data of the image recognition model may include image data and identification data identifying an item labeled therewith.

When the input feature vector is extracted from the image data and input to the image recognition model, the target feature vector may be output.

The image recognition model may be learned to minimize a cost function indicating a difference between the inference result representing the object feature vector and the item identification data, which is labeling data.

The image recognition model may be stored in memory 170.

In another embodiment, the refrigerator may transmit an image photographing the inner portion of the refrigerator to the AI server 200. The AI server 200 may store the image recognition model in the memory 230.

The AI server 200 may recognize an item from the image received from the refrigerator using the image recognition model. The AI server 200 may transmit identification data identifying the recognized an item to the refrigerator.

The processor 180 may grasp what item is taken in or taken out from the refrigerator by comparing a state before the item is taken in or taken out from the refrigerator with the state after the item is taken in or taken out from the refrigerator.

The processor 180 acquires accumulation state information on the corresponding item of another refrigerator as the item is detected to be taken in or taken out from the refrigerator (S503).

In a case where the item is detected to be taken in or taken out from the refrigerator, the processor 180 may request stock state information of the corresponding item from another refrigerator provided in the home through the communication unit 110.

The communication unit 110 of the refrigerator may include a short range wireless communication module, and exchange information with another refrigerator using the short range wireless communication module.

The processor 180 may receive stock state information of a corresponding item from another refrigerator.

Stock status information may include at least one of the quantity of the item, frequency in which the item is taken out from the refrigerator, and frequency in which the item is taken in the refrigerator again.

The frequency in which the item is taken out from the refrigerator may indicate the quantity of the item released over a period of time.

The frequency in which the item is taken in the refrigerator may indicate the quantity of the item which is taken in the refrigerator over a period of time.

The processor 180 compares the stock state information of the corresponding item with the stock state information of another refrigerator (S505).

The processor 180 outputs management guide which guides the management of the item according to the comparison result (S507).

The processor 180 may output the management guide of the item through the display unit 151 or the sound output unit 152.

The management guide of the item may include at least one of a notification indicating the insufficiency of the item, a notification indicating the sufficiency of the item, a notification indicating the movement of the item from another refrigerator, and a notification indicating that the purchase of the item is necessary.

In one embodiment, in a state where the processor 180 detects that the item is taken out from the refrigerator, in a case where there is no stock of the item and there is a stock of the item in another refrigerator, the processor 180 may output management guide indicating that there is a stock of the item in another refrigerator. In this case, the management guide may include a notification to move the item from another refrigerator to the refrigerator.

As another example, the processor 180 may output a notification indicating that the purchase of the item is necessary in a case where there are no stocks of the item in own refrigerator and other refrigerators in a state where the processor detects that the item is taken out from the refrigerator

Hereinafter, the embodiment of FIG. 5 will be described in more detail.

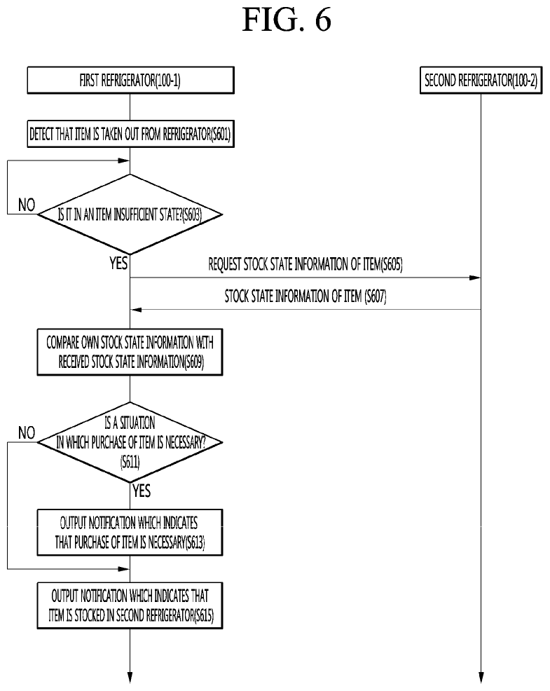

FIG. 6 is a ladder diagram illustrating a method for managing an item of a refrigeration system according to an embodiment of the present invention.

In FIG. 6, the refrigeration system may include a first refrigerator 100-1 and a second refrigerator 100-2. However, the refrigeration system need not be limited to this and may include more refrigerators.

Each of the first refrigerator 100-1 and the second refrigerator 100-2 may include all the components of FIG. 4.

Referring to FIG. 6, the processor 180 of the first refrigerator 100-1 detects that the item is taken out from the refrigerator (S601).

The processor 180 may identify the item which is taken out from the refrigerator from the image photographed by the camera 121 using the image recognition model.

The processor 180 of the first refrigerator 100-1 determines whether the item which is taken out from the refrigerator is in an item insufficient state in the first refrigerator 100-1 (S603).

The processor 180 may periodically store the stock state information of the first refrigerator 100-1 in the memory 170. The processor 180 may periodically acquire the quantity of each item, the frequency in which the item is taken out from the refrigerator, and the frequency in which the item is taken in the refrigerator, based on the image photographed by the camera 121.

The processor 180 may determine the state of the item as an item insufficient state in a case where the item which is taken out from the refrigerator is present in a quantity less than or equal to a preset quantity.

In a case where the processor 180 of the first refrigerator 100-1 determines that the item is in an insufficient state, the processor 180 requests the stock state information of the item from the second refrigerator 100-2 through the communication unit 110 (S605).

In a case where the state of the item which is taken out from the refrigerator is in an item sufficient state, the processor 180 may request stock state information of the corresponding item from one or more other refrigerators provided in the home through the communication unit 110.

The processor 180 of the first refrigerator 100-1 receives stock state information of the item from the second refrigerator 100-2 (S607).

In response to the request received from the first refrigerator 100-1, the second refrigerator 100-2 may transmit the storage state information of the item existing in the refrigerator to the first refrigerator 100-1.

The stock state information of the item may include a quantity of the item currently stored in the second refrigerator 100-2 and an expected time of exhaustion of the item. The expected time of exhaustion of an item can be determined by the frequency in which the item is taken out from the refrigerator.

For example, in a case where particular three items are taken out from the refrigerator for one day and the quantity of the remaining item is six, the expected time of exhaustion may be two days after from the current time.

The processor 180 of the first refrigerator 100-1 compares own stock state information with stock state information received from the second refrigerator 100-2 (S609).

The processor 180 of the first refrigerator 100-1 determines whether a situation in which the purchase of an item is necessary according to the comparison result (S611).

In a case where the quantity of the item which is taken out from the refrigerator is present in the first refrigerator 100-1 by the preset quantity or less and is present in the second refrigerator 100-2 by the preset quantity or less, the processor 180 can determine as a situation in which the purchase of an item is necessary.

In a case where an item is present in the second refrigerator 100-2 by the quantity more than the reset quantity, the processor 180 can determine as a situation in which the purchase of the item is unnecessary.

In a case where the processor 180 of the first refrigerator 100-1 determines as a situation in which the purchase of the item is necessary, the processor 180 outputs a notification indicating that the purchase of the item is necessary (S613).

Meanwhile, the processor 180 may acquire an expected purchase time of the item based on the quantity of the item provided in the second refrigerator 100-2 and the quantity of the item provided in the first refrigerator 100-1.

For example, in a case where the number of an item included in the first refrigerator 100-1 is 0, the number of an item included in the second refrigerator 100-2 is 6, and the frequency in which the item is taken out from the refrigerator is three per day, the processor 180 may output a notification indicating that the purchase of the item is necessary before two days.

In a case where the processor 180 of the first refrigerator 100-1 determines as a situation in which the purchase of the item is unnecessary, the processor 180 outputs a notification indicating that the item is stored in the second refrigerator 100-2 (S615).

In a case where the processor 180 determines as a situation in which the purchase of the item is unnecessary, the processor 180 may additionally output a notification to move the corresponding item to the first refrigerator 100-1 from the second refrigerator 100-2.

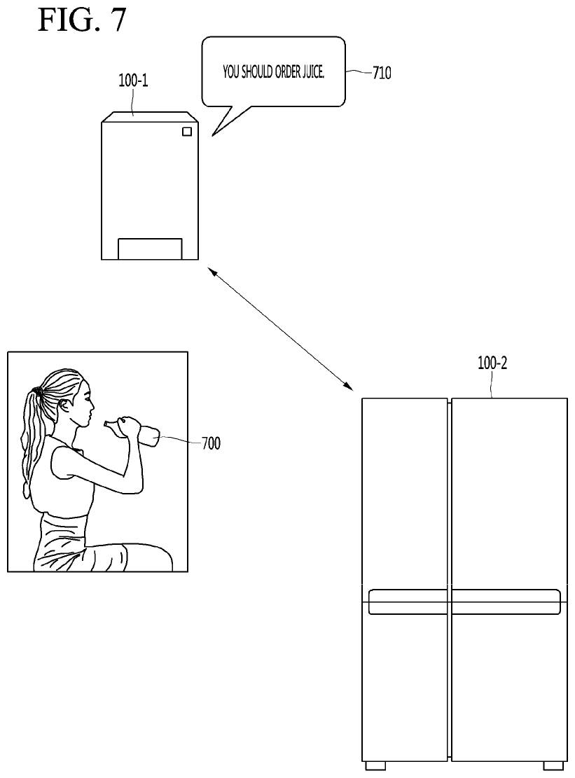

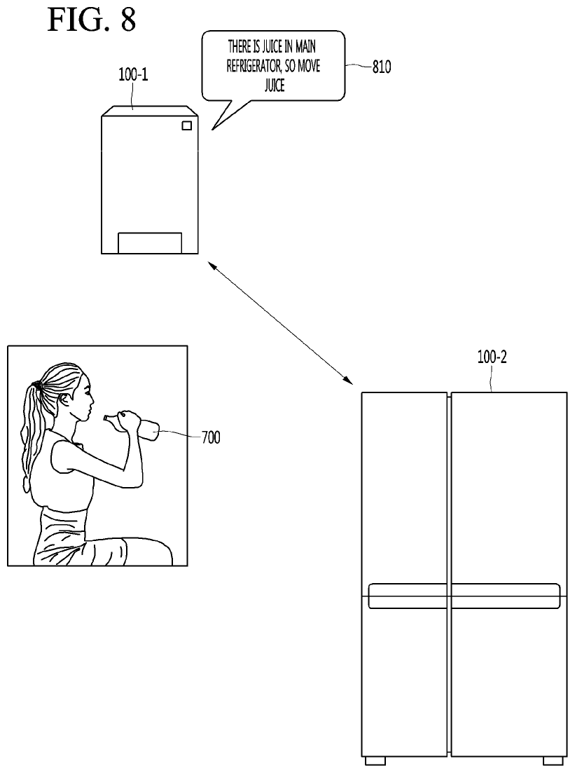

The embodiment of FIG. 6 will be described with reference to FIGS. 7 and 8.

FIGS. 7 and 8 are diagrams illustrating a detailed scenario of a method for managing an item of a refrigeration system in a case where an item is taken out from the refrigerator according to an embodiment of the present invention.

Referring to FIG. 7, it is assumed that the user takes out the juice 700 from the first refrigerator 100-1.

The first refrigerator 100-1 may detect that the juice 700 is taken out from the refrigerator based on the image photographed by the camera 121 provided therein. The first refrigerator 100-1 may detect that the juice 700 is released from the image by using the image recognition model.

In a case where the door is opened through a door sensor (not illustrated), the first refrigerator 100-1 may activate the camera 121 to photograph an image. The first refrigerator 100-1 may detect the item which is taken out from the refrigerator from the photographed image.

The first refrigerator 100-1 may determine whether the state where the juice 700 is taken out from the refrigerator is in an insufficient state based on its stock state information.

The first refrigerator 100-1 may determine that the juice 700 is in an insufficient state in a case where the juice 700 is stored in the first refrigerator 100-1 by a preset amount or less.

The first refrigerator 100-1 may transmit a request message requesting stock state information of the juice 700 to the second refrigerator 100-2.

The first refrigerator 100-1 may receive stock state information of the juice 700 from the second refrigerator 100-2 in response to the request message transmitted to the second refrigerator 100-2.

The first refrigerator 100-1 may determine whether a situation in which the purchase of the juice 700 is necessary, based on the received stock state information of the juice 700. The first refrigerator 100-1 may output a notification 710 indicating that the juice 700 needs to be purchased in a case where the juice 700 is stored in the second refrigerator 100-2 by a preset quantity or less.

Meanwhile, in a case where the juice 700 is stored in the second refrigerator (100-2) by a quantity exceeding a preset quantity, the first refrigerator (100-1) can determine as a situation in which the purchase of juice 700 is not necessary.

In this case, as illustrated in FIG. 8, since the juice 700 is sufficiently stored in the second refrigerator 100-2, the first refrigerator 100-1 may output the notification 810 that please move the juice 700 to the first refrigerator 100-1.

As such, according to an embodiment of the present invention, the user may be provided with a guide on the movement of the item without having to directly grasp the stock state of the item in the refrigerator.

Accordingly, the user can easily manage the item in the interior.

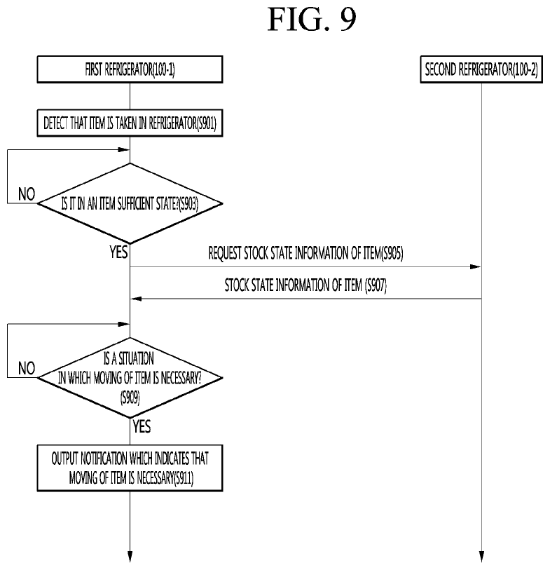

Next, FIG. 9 will be described.

FIG. 9 is a ladder diagram illustrating a method for managing an item of a refrigeration system according to another embodiment of the present invention.

Referring to FIG. 9, the processor 180 of the first refrigerator 100-1 detects that the item is taken in or taken out from the refrigerator (S901).

The processor 180 may identify an item from an image photographed by the camera 121 using an image recognition model.

The processor 180 may detect that the item is taken in the refrigerator when the item is identified and the item is newly stocked into the store.

The processor 180 of the first refrigerator 100-1 determines whether the stock state of the item which is detected that the item is taken in the refrigerator is an item sufficient state (S903).

The processor 180 may determine the stock state of the item as an item sufficient state in a case where the item is stored in a preset quantity or more.

As another example, the processor 180 may determine the stock state of the item as an item sufficient state in a case where the item is expected to be provided in a preset quantity or more by a specific time point in consideration of the frequency of exhaustion of the item.

The frequency of exhaustion of the item may be the quantity in which the item is taken out from the refrigerator per day. For example, if the frequency of exhaustion of the item is three per day, the current stock quantity is 30, and after one week, the stock quantity is 5 or more, the processor 180 may determine the stock state of the item as an item sufficient state.

In a case where the processor 180 of the first refrigerator 100-1 determines that the stock state of the item is an item sufficient state, the processor 180 requests the stock state information of the item from the second refrigerator 100-2 through the communication unit 110. (S905).

The processor 180 may transmit a request message for requesting stock state information of the corresponding item of the second refrigerator 100-2 to determine the stock state of the item which is taken in the refrigerator, through the communication unit 110.

The processor 180 of the first refrigerator 100-1 receives stock state information of the item from the second refrigerator 100-2 through the communication unit 110 (S907).

The processor 180 of the first refrigerator 100-1 determines whether a situation in which it is necessary to move the item based on the stock state information of the item received from the second refrigerator 100-2 (S909).

According to an embodiment of the present disclosure, in a case where the quantity of the item stored in the second refrigerator 100-2 is less than or equal to the preset quantity, the processor 180 may determine as a situation in which the item needs to move to the second refrigerator 100-2.

In a case where it is determined as a situation in which the item needs to be moved, the processor 180 of the first refrigerator 100-1 outputs a notification indicating that the item needs to be moved to the second refrigerator 100-2 (S911).

The processor 180 may display a notification indicating that the movement of the item to the second refrigerator 100-2 is necessary on the display unit 151 or output as the audio form through the sound output unit 152.

The processor 180 can also output the quantity to move to the second refrigerator 100-2 based on the stock state information of the item provided in the first refrigerator 100-1 and the stock state information of the item received from the second refrigerator 100-2.

For example, in a case where the preset number is 10 and 20 items are stored in the first refrigerator 100-1, the processor 180 can output a notification that the 10 items move to the second refrigerator 100-1.

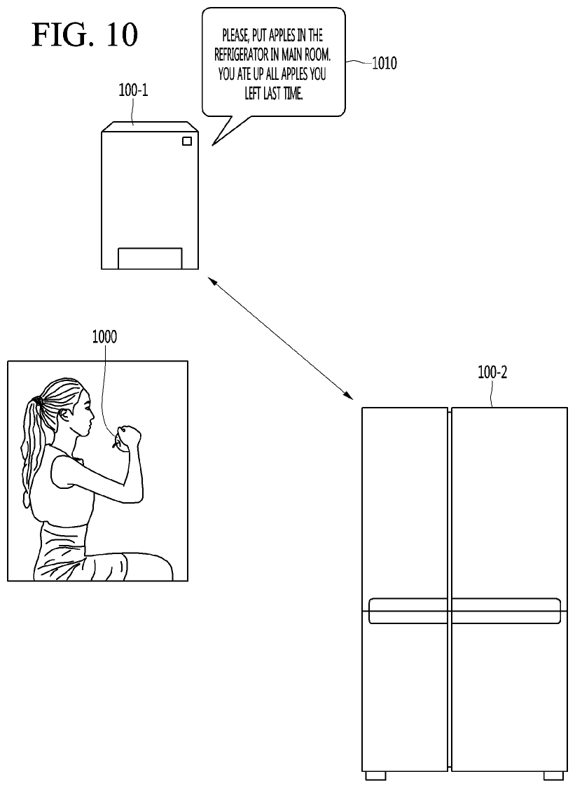

FIG. 10 is a view for explaining a specific scenario with respect to the item management method of the refrigeration system, in a case where the item is taken in the refrigerator according to an embodiment of the present invention.

Referring to FIG. 10, it is assumed that a user takes an apple 1000 in the first refrigerator 100-1.

The first refrigerator 100-1 may identify the apple 1000 from an image photographed by the camera 121 provided therein using the image recognition model.

In a case where the identified apple 1000 is stored, the first refrigerator 100-1 may detect that the apple 1000 is taken in the refrigerator.

The first refrigerator 1000-1 may determine that the stock state of the apples 1000 is in a sufficient state in a case where the apples 1000 are stored in the first refrigerator 100-1 by a preset number or more.

In a case where it is determined that the stock state of the apple 1000 is in a sufficient state, the first refrigerator 100-1 may request the stock state information of the apple from the second refrigerator 100-2.

In a case where the first refrigerator 100-1 stores apples in the second refrigerator 100-2 by less than a preset quantity, based on the stock state information of the apples received from the second refrigerator 100-2, it can be recognized as a situation in which the apple needs to be moved.

In a case where it is determined as a situation in which the apple needs to be moved, the first refrigerator 100-1 may output a notification 1010 that the apple is taken in the second refrigerator 100-2.

As such, according to an embodiment of the present invention, the user may be provided with a guide on the movement of the item without having to directly grasp the stock state of the item in the refrigerator.

Accordingly, the user can easily manage the item in the refrigerator.

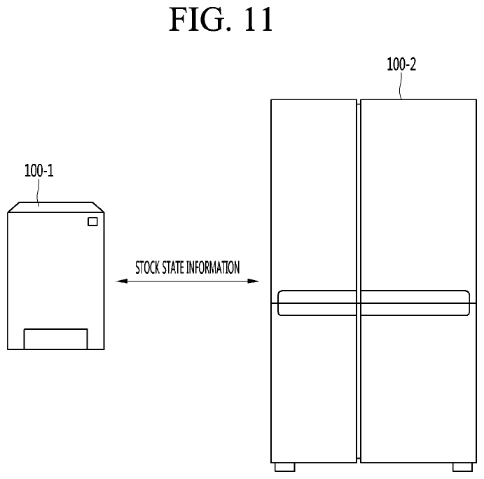

FIG. 11 is a view for explaining an example in which the first refrigerator and the second refrigerator automatically perform item management without user intervention, according to an embodiment of the present invention.

The first refrigerator 100-1 and the second refrigerator 100-2 may exchange stock state information of the item with each other through a short range wireless communication module.

Each of the first refrigerator 100-1 and the second refrigerator 100-2 may be connected by an IoT server (not illustrated) managing states of the first refrigerator 100-1 and the second refrigerator 100-2.

The first refrigerator 100-1 and the second refrigerator 100-2 may periodically exchange stock state for each of the plurality of items.

The first refrigerator 100-1 and the second refrigerator 100-2 may output an item management guide for managing the item based on the exchanged stock state.

For example, in a case where a specific item is stored in the first refrigerator 100-1 by a preset quantity or more, and the specific item is stored in the second refrigerator 100-2 by less than a predetermined quantity, the first refrigerator 100-1 or the second refrigerator 100-2 may output a notification notifying the movement of a specific item from the first refrigerator 100-1 to the second refrigerator 100-2.

As described above, according to an exemplary embodiment of the present invention, the refrigerators can automatically guide management about the exhaustion or movement of the item, by exchanging the stock state of the item without the user's intervention.

The present invention described above can be embodied as the computer readable codes on a medium in which a program is recorded. The computer-readable medium includes all kinds of recording devices in which data that can be read by a computer system is stored. Examples of computer-readable media include hard disk drives (HDDs), solid state disks (SSDs), silicon disk drives (SDDs), ROMs, RAMs, CD-ROMs, magnetic tapes, floppy disks, optical data storage devices, and the like. In addition, the computer may also include a processor 180 of an artificial intelligence device.

What is claimed is:

1. A refrigerator which manages an item using artificial intelligence, comprising:
a communication unit configured to communicate with another refrigerator;
a camera configured to image an inner portion of the refrigerator; and
a processor configured to acquire a stock state information of the item from another refrigerator through the communication unit, in a case where the processor detects that the item is taken in or taken out from the refrigerator based on an image photographed by the camera, and to output management guide of the item, based on the acquired stock state information of the item.

2. The refrigerator of claim 1,
wherein the stock state information of the item includes at least one of a quantity stocked in another refrigerator, a frequency in which the item is taken in the refrigerator, and a frequency in which the item is taken out from the refrigerator.

3. The refrigerator of claim 2,
wherein the processor is configured to
determine whether the stock state of the item is in an insufficient state in the refrigerator, in a case where the processor detects that the item taken out from the refrigerator, request the stock state information of the item in another refrigerator, in a case where the stock state of the item is in an insufficient state, and
receive the stock state information of the item from another refrigerator according to the request.

4. The refrigerator of claim 3,
wherein the processor is configured to
output a first notification indicating that the purchase of the item is necessary, in a case where it is determined as a situation in which the purchase of the item is necessary, based on the received stock state information of the item.

5. The refrigerator of claim 4,
wherein the processor is configured to
output a second notification indicating that the item is stocked in another refrigerator, in a case where it is determined as a situation in which the purchase of the item is unnecessary, based on the received stock state information of the item.

6. The refrigerator of claim 5,
wherein the processor is configured to
further output a third alarm to move the item from another refrigerator to the refrigerator.

7. The refrigerator of claim 2,
wherein the processor is configured to
determine whether the stock state of the item is in a sufficient state, in a case where the processor detects that the item is taken in the refrigerator, and
receive the stock state information of the item from another refrigerator in a case where the stock state of the item is in a sufficient state.

8. The refrigerator of claim 7,
wherein the processor is configured to
output a notification to move the item to another refrigerator, in a case where it is determined that the item needs to be moved to another refrigerator, based on the received stock state information.

9. A method for managing an item of a refrigerator which manages an item, using artificial intelligence, the method comprising:
imaging an inner portion of the refrigerator;
acquiring stock state information of the item from another refrigerator, in a case where it is detected that the item is taken in or taken out from the refrigerator, based on an image photographed by a camera; and
outputting management guide of the item, based on the acquired stock state information of the item.

10. The method for managing an item of a refrigerator of claim 9,
wherein the stock state information of the item includes at least one of a quantity stocked in another refrigerator, a frequency in which the item is taken in the refrigerator, and a frequency in which the item is taken out from the refrigerator.

11. The method for managing an item of a refrigerator of claim 10, further comprising:
determining whether the stock state of the item is in an insufficient state in the refrigerator, in a case where it is detected that the item is taken out from the refrigerator;
requesting the stock state information of the item in another refrigerator, in a case where the stock state of the item is in an insufficient state; and
receiving the stock state information of the item from another refrigerator according to the request.

12. The method for managing an item of a refrigerator of claim 11,
wherein the outputting management guide includes:
outputting a first notification indicating that the purchase of the item is necessary, in a case where it is determined that the purchase of the item is necessary, based on the received stock state information of the item.

13. The method for managing an item of a refrigerator of claim 12,
wherein the outputting management guide includes:
outputting a second notification indicating that the item is stocked in another refrigerator, in a case where it is determined that the purchase of the item is unnecessary, based on the received stock state information of the item.

14. The method for managing an item of a refrigerator of claim 13,
wherein the outputting management guide further includes:
outputting a third notification to move the item from another refrigerator to the refrigerator.

15. The method for managing an item of a refrigerator of claim 10, further comprising:
determining whether the stock state of the item is in a sufficient state, in a case where it is detected that the item is taken in the refrigerator, and
receiving the stock state information of the item from another refrigerator, in a case where the stock state of the item is in a sufficient state.

16. The method for managing an item of a refrigerator of claim 15,
wherein the outputting management guide includes:
outputting a notification to move the item to another refrigerator, in a case where it is determined that the item needs to be moved to another refrigerator, based on the received stock state information.
